(19) United States
(12) Patent Application Publication
(10) Pub. No.: US 2003/0056883 A1
(43) Pub. Date: Mar. 27, 2003

(54) Method for making spunbond nonwoven fabric from multiple component filaments

(76) Inventors: Vishal Bansal, Richmond, VA (US); Michael C. Davis, Midlothian, VA (US); James E. Van Trump, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/963,192

(22) Filed: Sep. 26, 2001

(51) Int. Cl. D04H 3/16; B32B 1/00; B29C 47/00

(52) U.S. Cl. 156/181; 156/167; 156/180; 156/296; 156/244.11

(57) ABSTRACT

A method for preparing multiple component spunbond nonwoven fabrics in which the individual polymer components are extruded from separate orifices and contacted and fused after extrusion to form multiple component filaments that are drawn, quenched, and collected to form a spunbond web. The method is especially suitable for forming multiple component spunbond webs in which the different polymeric components have significantly different viscosities, for example in forming nonwoven webs comprising multiple component filaments having three-dimensional helical crimp.

### BACKGROUND OF THE INVENTION

1. Field of the Invention

This invention relates to a method for preparing multiple component spunbond nonwoven fabrics. More specifically, the current invention relates to a method for forming a multiple component spunbond web from individual polymer components that are extruded from separate orifices and contacted and fused after extrusion to form multiple component filaments that are collected to form the spunbond web.

2. Description of Related Art

Nonwoven webs made from multiple component filaments are known in the art. For example, it is known to prepare bicomponent spunbond nonwoven webs by simultaneously extruding two combined polymeric streams through a series of capillaries with the polymeric components being combined to form a single layered bicomponent stream prior to extrusion from the capillaries. When the viscosities of the two polymeric streams are not closely matched, the equilibrating pressures of the bicomponent polymer stream within a capillary results in a velocity differential between the two polymer melt streams inside the capillary. When a bicomponent filament is formed by spinning two polymers having significantly different viscosities as a layered mass through a single spin orifice, the filament has a tendency to bend up towards the spinneret face immediately after exiting the spin orifice, a phenomenon which is sometimes referred to in the art as “dog-legging”. In some cases, the filament can contact the spinneret face and adhere to the spinneret surface. This is especially a problem when the polymers are arranged in a side-by-side relation in a bicomponent filament. In some cases, the lower viscosity polymer stream may even wrap around the higher viscosity polymer upon exiting the spinneret

Nonwoven webs made from splittable multiple component filaments are also known in the art. For example International application WO 99/48668 describes a method for forming multiple component nonwoven fabrics. In one embodiment described therein, two incompatible polymers are spun through two sets of inclined capillaries in which the two sets of capillaries are inclined to converge toward each other in a downstream direction. The centerlines of the capillaries in one set lie along axes that, when extended beyond the spinneret, are offset and non-intersecting with axes along which the centerlines of the other set of capillaries lie, such that the centerlines of the extruded polymer streams are directed along non-intersecting axes. Splittable multiple component fibers are useful in forming fine denier fabrics because the multiple fiber segments are joined to each other during at least a portion of the drawing and attenuation process, thereby forming a thicker combined fiber that can be more readily drawn and attenuated. By extruding the polymer streams such that their axes are non-intersecting, the surface area over which the polymer streams are contacted is reduced, resulting in multiple component fibers which are more readily splittable into finer denier filaments.

There is a need to provide a new method for forming spunbond filaments, and corresponding spunbond webs, in which the processing conditions for dissimilar polymeric components can be optimized individually and in which the polymeric components adhere to each other without splitting to form filaments having three-dimensional helical crimp.

### SUMMARY OF THE INVENTION

This invention is directed to a method for forming a spunbond web, comprising the steps of:

providing a spin pack comprising a spinneret having at least one face encompassing a plurality of combined orifices, each combined orifice being formed by cooperating first and second extrusion capillaries, each extrusion capillary having an axis along a centerline, wherein within each combined orifice the first and second extrusion capillaries are oriented to converge toward each other in a downstream direction with an included angle between the centerlines of the first and second extrusion capillaries, the axes along the centerlines of the capillaries intersecting when extended beyond the spinneret face;

simultaneously extruding

(i) a first melt-processable polymer through the first plurality of capillaries to form a plurality of sub-streams comprising the first polymer and

(ii) a second melt-processable polymer through the second plurality of capillaries to form a plurality of sub-streams comprising the second polymer, the first polymer and second polymer having significantly different viscosities,

contacting each of the first and second polymer sub-streams issuing from each combined orifice after exiting the spinneret whereby the sub-streams fuse to form a plurality of multiple component filaments;

quenching the multiple component filaments;

drawing the multiple component filaments; and

collecting the drawn multiple component filaments on a collecting surface to form a multiple component spunbond web.

The invention is further directed to heating steps the multiple component spunbond web to develop in crimp the multiple component filaments.

### BRIEF DESCRIPTION OF THE DRAWINGS

FIG. 1 is a schematic illustration of an apparatus suitable for producing spunbond nonwoven fabrics.

FIG. 2 is a lateral cross-sectional view of a post-coalescence spinneret suitable for producing spunbond nonwoven fabrics comprising side-by-side filaments according to the process of the current invention.

FIG. 3A is a lateral cross-sectional view of a post-coalescence bicomponent spinneret suitable for forming eccentric sheath-core spunbond filaments showing the relationship between the central axes of the extrusion capillaries. FIG. 3B is a plan view in a direction perpendicular to the spinneret face.

### DETAILED DESCRIPTION OF THE INVENTION

The current invention is directed toward a method for forming spunbond nonwoven webs made from multiple component filaments. In a preferred embodiment, the polymeric components in the multiple component filaments are chosen such that the multiple component fibers develop three-dimensional helical crimp. The process of the invention includes the steps of extruding a first melt-processable polymer through a first plurality of extrusion orifices in a spinneret, simultaneously extruding a second melt-processable polymer through a second plurality of extrusion orifices in the spinneret. Each of the first orifices cooperate with a second extrusion orifice to form a plurality of combined orifices. Individual polymer sub-streams issuing from each orifice within a combined orifice contact and fuse after extrusion to form a plurality of multiple component filaments which are drawn, quenched and laid down on a collecting surface to form a spunbond web. A spinneret in which at least two polymer sub-streams are contacted after extrusion from the spinneret is referred to herein as a “post-coalescence” spinneret.

The term “polymer” as used herein, generally includes but is not limited to, homopolymers, copolymers (such as for example, block, graft, random and alternating copolymers), terpolymers, etc. and blends and modifications thereof. Furthermore, unless otherwise specifically limited, the term “polymer” shall include all possible geometric configurations of the material. These configurations include, but are not limited to isotactic, syndiotactic and random symmetries.

The term “polyolefin” as used herein, is intended to mean any of a series of largely saturated open chain polymeric hydrocarbons composed only of carbon and hydrogen atoms. Typical polyolefins include polyethylene, polypropylene, polymethylpentene and various combinations of the ethylene, propylene, and methylpentene monomers.

The term “polyethylene” (PE) as used herein is intended to encompass not only homopolymers of ethylene, but also copolymers wherein at least 85% of the recurring units are ethylene units.

The term “polypropylene” as used herein is intended to embrace not only homopolymers of propylene but also copolymers where at least 85% of the recurring units are propylene units.

The term “polyester” as used herein is intended to embrace polymers wherein at least 85% of the recurring units are condensation products of dicarboxylic acids and dihydroxy alcohols with linkages created by formation of ester units. This includes aromatic, aliphatic, saturated, and unsaturated di-acids and di-alcohols. The term “polyester” as used herein also includes copolymers (such as block, graft, random and alternating copolymers), blends, and modifications thereof. Examples of polyesters include poly(ethylene terephthalate) (PET) which is a condensation product of ethylene glycol and terephthalic acid, and poly(trimethylene terephthalate) which is a condensation product of 1,3-propanediol and terephthalic acid.

The terms “nonwoven fabric” or “nonwoven web” as used herein mean a structure of individual fibers, filaments, or threads that are positioned in a random manner to form a planar material without an identifiable pattern, as opposed to a knitted or woven fabric.

The term “multiple component filament” as used herein refers to any filament that is composed of at least two distinct polymers which have been spun together to form a single filament. By the term “distinct polymers” it is meant that each of the at least two polymers is arranged in a distinct substantially constantly positioned zone across the cross-section of the multiple component filaments and extends substantially continuously along the length of the filaments. The at least two distinct polymeric components useable herein can be chemically different or they can be chemically the same polymer, but have different physical characteristics, such as tacticity, intrinsic viscosity, melt viscosity, etc. Multiple component filaments are distinguished from filaments which are extruded from a homogeneous melt blend of polymeric materials in which zones of distinct polymers are not formed. Multiple component filaments useful in the current invention preferably have laterally eccentric cross-sections, that is the polymeric components are arranged in an eccentric relationship in the cross-section of the filament. For example, the distinct polymers may be arranged in a side-by-side configuration or an eccentric sheath-core configuration. Preferably, the multiple component filament is a bicomponent filament which is made of two distinct polymers arranged in a side-by-side configuration. If the multiple component filament is a bicomponent filament having an eccentric sheath-core configuration, preferably the lower melting polymer is in the sheath to facilitate thermal bonding of the final nonwoven fabric.

The term “spunbond” filaments as used herein means filaments which are formed by extruding molten thermoplastic polymer material as filaments from a plurality of fine, usually circular, capillaries of a spinneret with the diameter of the extruded filaments then being rapidly reduced by drawing and then quenching the filaments. Other filament cross-sectional shapes such as oval, multi-lobal, etc. can also be used. Spunbond filaments are generally continuous and have an average diameter of greater than about 5 micrometers. Spunbond nonwoven fabrics or webs are formed by laying spunbond filaments randomly on a collecting surface such as a foraminous screen or belt. Spunbond webs are generally bonded by methods known in the art such as by hot-roll calendering or by passing the web through a saturated-steam chamber at an elevated pressure. For example, the web can be thermally point bonded at a plurality of thermal bond points located across the spunbond fabric. The term “multiple component spunbond web” as used herein refers to a nonwoven web comprising multiple component filaments. The term “bicomponent spunbond web” as used herein refers to a nonwoven web comprising bicomponent filaments.

While the process of the current invention can be used to prepare a wide range of multiple component spunbond webs, it is especially useful for preparing spunbond webs from combinations of polymers having widely different viscosities to provide spunbond filaments having three-dimensional helical crimp. While quantitative measurement of the melt viscosities are not available, it can be determined from indirect indicators (melt pump pressures while spinning, etc) when the two polymers have viscosities that are significantly different. Typically, characterization of polymers for different chemical classes is done in different units. For example, by specifying intrinsic viscosity for polyester, melt index (MI) for polyethylene, or melt flow rate (MFR) for polypropylene, their melt viscosities at different temperatures can be determined. Generally speaking, all of these are indicators of molecular weight, which are directly related to the melt viscosity.

Combinations of polymers suitable for preparing bicomponent spunbond webs comprising filaments having three-dimensional helical crimp include poly(ethylene terephthalate)/polyethylene, poly(ethylene terephthalate)/polypropylene, isotactic-polypropylene/polyethylene, poly(ethylene terephthalate)/poly(trimethylene terephthalate), atactic polypropylene/isotactic polypropylene, atactic polypropylene/high density polyethylene, PETG/poly(trimethylene terephthalate), PETG/poly(butylene terephthalate), etc. PETG refers to a class of copolyesters which are copolymers of ethylene glycol and terephthalic acid with a glycol that is different than ethylene glycol. Examples of PETG polymers include those manufactured and marketed by Eastman Chemical Company under the trade name Eastar® which comprise poly(ethylene terephthalate) modified with 1,4-cyclohexanedimethanol. Either or both of the polymeric components can be crystalline or amorphous.

When multiple component spunbond filaments having high degrees of three-dimensional spiral crimp are desired, for example when preparing multiple component spunbond webs having elastic stretch, the polymeric components may be selected according to the teaching in U.S. Pat. No. 3,671,379 to Evans, et al. (Evans), which is hereby incorporated by reference. The bicomponent filaments of Evans have a high degree of helical crimp, generally acting as springs, having a recoil action whenever a stretching force is applied and released. In Evans, the polymeric components are partly crystalline polyesters, the first of which has chemical repeat-units in its crystalline region that are in a non-extended stable conformation that does not exceed 90 percent of the length of the conformation of its fully extended chemical repeat units and the second of which has chemical repeat-units in its crystalline region that are in a conformation more closely approaching the length of the conformation of its fully extended chemical repeat-units than the first polyester. The term “partly crystalline” as used in defining the filaments of Evans serves to eliminate from the scope of the invention the limiting situation of complete crystallinity where the potential for shrinkage would disappear. The amount of crystallinity, defined by the term “partly crystalline” has a minimum level of only the presence of some crystallinity (i.e. that which is first detectable by X-ray diffraction means) and a maximum level of any amount short of complete crystallinity. Examples of suitable fully extended polyesters are poly(ethylene terephthalate), poly (cyclohexyl 1,4-dimethylene terephthalate), copolymers thereof, and copolymers of ethylene terephthalate and the sodium salt of ethylene sulfoisophthalate. Examples of suitable non-extended polyesters are poly(trimethylene terephthalate), poly(tetramethylene terephthalate), poly(trimethylene dinaphthalate), poly(trimethylene bibenzoate), and copolymers of the above with ethylene sodium sulfoisophthalate, and selected polyester ethers. When ethylene sodium sulfoisophthalate copolymers are used, it is preferably the minor component, i.e. present in amounts of less than 5 mole percent and preferably present in amounts of about 2 mole percent. The degree of spiral crimp can be increased by increasing the orientation in the high shrinkage (non-extended) polymer, which can be achieved by increasing the molecular weight, and hence the melt viscosity of the non-extended polymer. In a preferred embodiment, the non-extended polymer is poly(trimethylene terephthalate) having an intrinsic viscosity of greater than about 0.90 dl/g and the extended polymer is poly(ethylene terephthalate) having an intrinsic viscosity of less than about 0.55 dl/g.

Other partly crystalline polymers which are suitable for use in the current invention include syndiotactic polypropylene which crystallizes in an extended conformation and isotactic polypropylene which crystallizes in a non-extended, helical conformation.

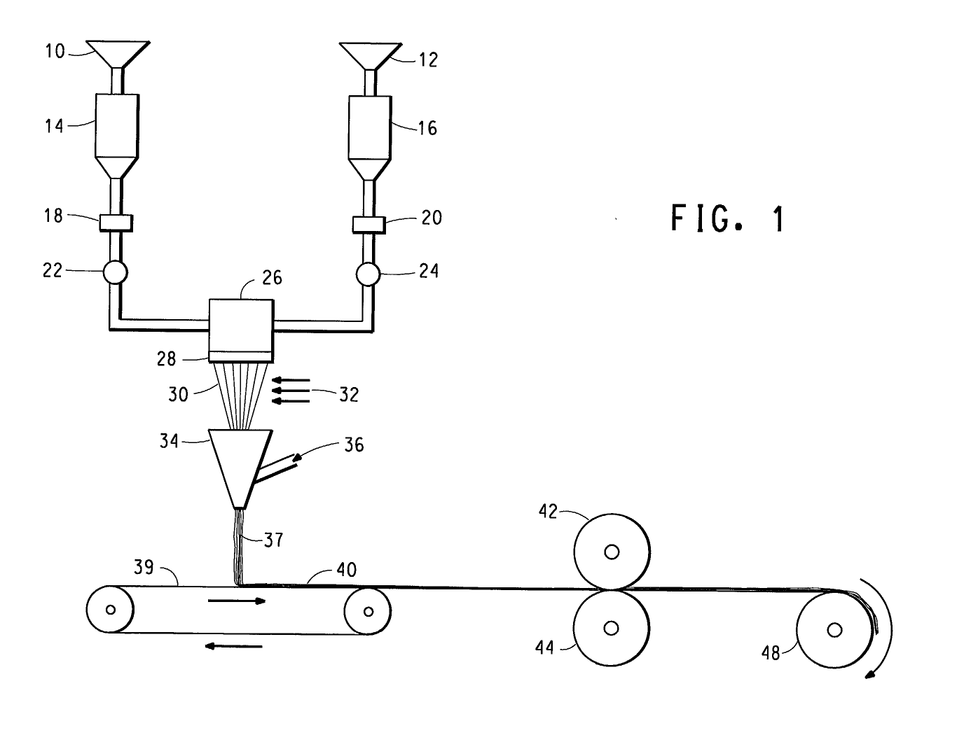

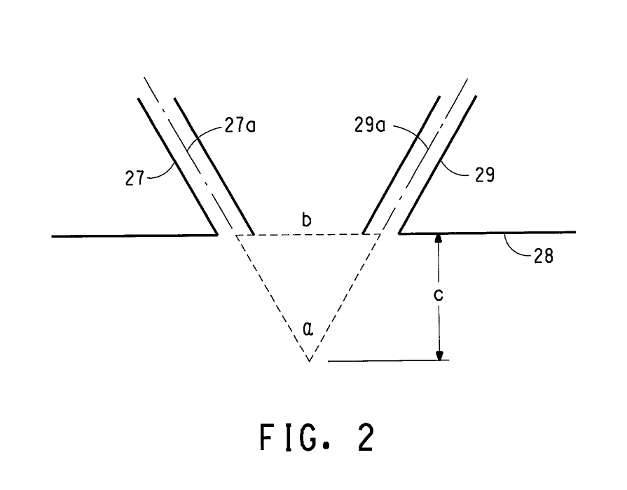

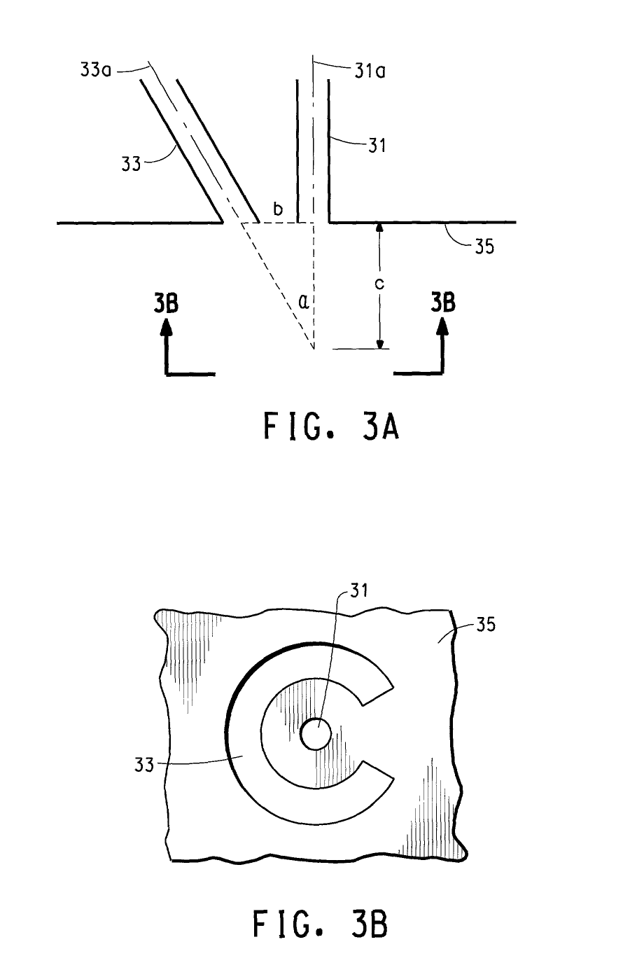

An apparatus suitable for producing a bicomponent spunbond web is schematically illustrated in FIG. 1. In this apparatus, two thermoplastic polymers are fed into the hoppers 10 and 12, respectively. The polymer in hopper 10 is fed into the extruder 14 and the polymer in the hopper 12 is fed into the extruder 16. The extruders 14 and 16 each melt and pressurize the polymer and push it through filters 18 and 20 and metering pumps 22 and 24, respectively. The polymer from hopper 10 and the polymer from hopper 12 are metered to separate sets of capillaries within spin pack 26. The melted polymers exit the spin pack 26 through a plurality of capillary openings on spinneret face 28, as depicted in FIGS. 2-3A, 3B and described in greater detail, below.

FIG. 2 is a schematic cross-sectional view of a spinneret suitable for making spunbond, side-by-side, bicomponent filaments using the process of the current invention which shows the orientation of extrusion capillaries 27 and 29. The first polymeric component is extruded through capillary 27 to form a first polymeric sub-stream and the second polymeric component is extruded through capillary 29 to form a second polymeric sub-stream. It should be noted that there is no requirement that any particular polymer be designated as the first or second. Neither is there any requirement that the first polymer or the second polymer travel through a particular capillary. The designations are for convenience in identification. Capillaries 27 and 29 are inclined to converge toward each other in a downstream direction. Capillary centerlines 27a and 29a lie along axes which are angled substantially directly toward each other and which intersect when extended beyond spinneret face 28 with the axes being co-planar in a vertical plane with respect to the spinneret face. In a preferred embodiment, the included angle α between capillary centerlines 27a and 29a is between about 10 and 145 degrees, more preferably between about 30 and 90 degrees, and most preferably between about 45 and 75 degrees. Distance “c” is the vertical distance between the spinneret face 28 and the point of intersection of the axes along which the capillary centerlines lie and is referred to herein as the vertical travel distance. The vertical travel distance “c” is preferably between about 2 and 30 mils (0.05 and 0.76 mm), more preferably between about 3 and 20 mils (0.08 and 0.51 mm), most preferably between about 4 and 12 mils (0.10 and 0.30 mm). The distance “b”, which is the center-to-center distance between the two capillaries measured at the spinneret face, can be calculated as b=2*c*tan(α/2).

Because the pair of extrusion capillaries 27 and 29 cooperate to form a single bicomponent filament, they are collectively referred to herein as a “combined orifice”. The combined orifices can be arranged on spinneret face 28 in a conventional pattern (rectangular, staggered, etc.) with the spacing of the combined orifices set to optimize productivity and fiber quenching. The density of the combined orifices is typically in the range of 500 to 8000 combined orifices/meter width of the pack.

FIG. 3A is a schematic cross-sectional view of a spinneret suitable for forming eccentric, sheath-core spunbond filaments. Core polymer spin capillary 31 has a central axis 31a which is generally oriented substantially perpendicular to spinneret face 35. Annular capillary 33 is inclined at an angle α with respect to the central capillary 31. This is shown by central axis 33a with respect to the central capillary axis 31a. Annular capillary 33 is thus a conical annulus converging in a direction towards spinneret face 35. Central core spin orifice 31 is concentric with “C”-shaped annular sheath orifice 33. The included angle α is preferably between about 10 and 145 degrees, more preferably between about 30 and 90 degrees, and most preferably between about 45 and 75 degrees. Distance “c′” is the vertical travel distance between the spinneret face 35 and the projected point of intersection of central axes 31a and 33a. The vertical travel distance is preferably between about 2 and 30 mils (0.05 and 0.76 mm), more preferably between about 3 and 20 mils (0.08 and 0.51 mm), most preferably between about 4 and 12 mils (0.10 and 0.30 mm). The center-to-center distance “b′” between central axis 31a and annular axis 33a, measured at the spinneret face can be calculated using the formula b=c*tan(α).

FIG. 3B is a plan view of the spinneret viewed in direction 3B-B. The bicomponent filament formed by extrusion of the core and sheath polymers through the spinneret shown in FIG. 3B is an eccentric sheath-core filament because the core polymer is extruded through central spin orifice 31 and the sheath polymer is extruded through annular “C-shaped” orifice 33.

The “C”-shaped annular sheath orifice 33 shown in FIG. 3B can be replaced with a continuous circular “O”-shaped annular orifice (not shown) with the central orifice being positioned off-center of the “O”-shaped orifice. The annular “O”-shaped orifice can be formed by a conical annular sheath capillary so that the sheath polymer stream exits the orifice at an angle with respect to the core polymer stream which is extruded from the offset central orifice formed by a vertical capillary. The center-to-center distance “b” on the spinneret face between the central capillary axis and the annular axis corresponds to the shortest distance between the central capillary axis and the annular axis since the central capillary is not concentric with the “O”-shaped annular capillary. Alternately, the “O”-shaped annular sheath orifice can be replaced by a plurality of discrete orifices (not shown) which are placed in a circular or other pattern around an offset central orifice and formed by capillaries having axes oriented at an angle with respect to the central orifice axis.

The extrusion capillaries and spin pack design are selected to provide filaments having the desired cross-section and denier per filament. When the multiple component filaments are bicomponent filaments, the ratio of the two polymeric components in each filament is generally between about 10:90 to 90:10 based on volume (for example, measured as a ratio of metering pump speeds), preferably between about 30:70 to 70:30, and most preferably between about 40:60 to 60:40.

As shown in FIG. 1, bicomponent filaments 30 are formed when the first and second polymer sub-streams extruded from the spin capillaries of a combined orifice contact and fuse after extrusion from the spin orifices. The bicomponent filaments are cooled with quenching gas 32 and then drawn by a pneumatic draw jet 34 before being laid down on a collecting surface such as belt 39. The quenching gas 32 is provided by one or more conventional quench boxes (not shown) that direct the quench gas against the filaments at a rate of about 0.3 to 2.5 m/sec. Generally, the quench gas is air provided at ambient temperature (approximately 25° C.) but can either be refrigerated or heated to temperatures between about 0 C. and 150° C. Typically, two quench boxes facing each other from opposite sides of the line of filaments are used resulting in a co-current gas flow, i.e., the gas from the opposing quench boxes flows in the direction of filament travel. The length of the quench zone is selected so that the filaments are cooled to a temperature such that no further drawing occurs as they exit the quench zone and such that the filaments do not stick to each other. It is not generally required that the filaments be completely solidified at the exit of the quench zone.

The distance between the capillary openings and the draw jet is generally between about 30 and 130 cm, depending on the fiber properties desired. The quenched filaments enter pneumatic draw jet 34 where the filaments are drawn by attenuating gas 36, generally air, to fiber speeds in the range of from 2000 to 12,000 m/min. The tension applied to the filaments by the jet draws and elongates the filaments near the spinneret face. The substantially continuous spunbond filaments 37 preferably have an effective diameter of from 5 to 30 micrometers.

In one embodiment of the current invention, attenuating gas 36 is heated to a temperature sufficient to heat the bicomponent filaments and cause them to develop three-dimensional helical crimp. The three-dimensional helical crimp forms as a result of differential shrinkage between the polymeric components. Alternately, the spunbond web may be heated after laydown of the filaments to activate the three-dimensional helical crimp.

Filaments 37 are deposited as substantially continuous filaments onto a foraminous collector surface 39 such as a laydown belt or forming screen to form spunbond web 40. The distance between the exit of the draw jet 34 and the collector surface 39 can be varied depending on the properties desired in the nonwoven web, and generally ranges between about 13 and 76 cm. Vacuum suction is usually applied through the laydown belt to help pin down the fiber web.

Various methods can be used to bond web 40, for example, through-air bonding wherein heated gas, generally air, is passed through the web at a temperature sufficient to soften or melt the low-melting component to bond the filaments at their cross-over points. Through-air bonders generally include a perforated roller, which receives the web, and a hood surrounding the perforated roller. The heated gas is directed from the hood, through the web, and into the perforated roller. Alternate bonding methods that can be used include hydraulic needling or mechanical needling.

In a preferred embodiment, thermal point bonding or ultrasonic bonding is used. With reference to FIG. 1, web 40 can be bonded by passing it between thermal bonding rolls 42 and 44 before collecting on wind-up roll 48. Typically, thermal point bonding involves applying heat and pressure at discrete spots on the fabric surface, for example by passing the nonwoven layer through a nip formed by a heated, patterned calender roll and a smooth roll. During thermal point bonding, the lowest melting polymeric component in the multiple component filaments is partially melted in discrete areas corresponding to raised protuberances on the heated patterned roll to form fusion bonds and form a cohesive bonded nonwoven fabric. The pattern of the bonding roll may be any of those known in the art, and are preferably discrete point bonds. The bonding may be in continuous or discontinuous patterns, uniform or random points or a combination thereof. Preferably, the point bonds are spaced at intervals of about 5-40 per inch (2-16/cm). The bond points can be round, square, rectangular, triangular or other geometric shapes, and the percent bonded area can vary between about 3 to 70% of the surface of the spunbond nonwoven fabric.

The process of the current invention is not limited to the particular apparatus and processes described in connection with FIGS. 1-3. For example, one or more draw rolls can be used upstream of the draw jet for drawing of the fibers. When draw rolls are used, the draw jet functions as a laydown jet and also provides tension to keep the filaments from slipping on the draw rolls. In such an embodiment, when the polymers are selected according to Evans, the filaments are preferably heated to activate the three-dimensional helical crimp while under tension on the draw rolls. This is as described in co-pending application with Docket Number SS-3020 and also assigned to DuPont.

### EXAMPLE 1

This example illustrates preparation of a side-by-side bicomponent spunbond web from a polyester component and a polyethylene component having significantly different viscosities using a post-coalescence spinneret.

The spinneret orifices were round, having a diameter of 0.35 mm, and were arranged on the spinneret face in 17 rows, with the distance between the outside edges of the orifices of the outermost rows being 165 mm. Each row consisted of 59 combined orifices, each combined orifice consisting of two spin orifices (for a total of 118 orifices/row) with the spacing between the outermost pairs of combined orifices in each row being 560.9 mm. The spinneret capillaries in each of the combined orifices were arranged as shown in FIG. 2 with an included angle α between the capillary centerlines of 60 degrees and a vertical travel distance “c” of 8.7 mils (0.22 mm).

The spunbond web was made using an apparatus like that described above with regard to FIGS. 1 and 2. The polyester component of spunbond bicomponent filaments was poly(ethylene terephthalate) available from DuPont as Crystar® 4449 polyester having an intrinsic viscosity of 0.53 dl/g (measured according to ASTM D-2857 in hexafluoropropanol with 0.01 M sodium trifluoroacetate at 35° C.). The polyethylene component was a linear low density polyethylene (LLDPE) component available from Dow as ASPUN 6811A having a reported melt index of 27 g/10. The polyester resin was crystallized at a temperature of 180° C. and dried at a temperature of 120° C. to a moisture content of less than 50 ppm before use. The polyester component was heated to 290° C. and the LLDPE component was heated to 250° C. in separate extruders. The polymers were extruded, filtered, and metered to the side-by-side post-coalescence spinneret described above, which was maintained at 295° C. The transfer lines used for transporting polymer melts to the spin-pack further heated the polyester component to 290° C., and the LLDPE component to 280° C. Under the temperature conditions of the spin-pack, the melt viscosity of the polyester component was significantly higher than the LLDPE component, by at least a factor of two.

The polymer flow through each polyester capillary and each polyethylene capillary was adjusted to provide filaments that were 50 weight percent LLDPE and 50 weight percent polyester. The 1003 bicomponent filaments were cooled in a 15 inch (38.1 cm) long quenching zone with quenching air provided from two opposing quench boxes a temperature of 12° C. and velocity of 1 m/sec. The filaments passed into a pneumatic draw jet spaced 20 inches (50.8 cm) below the capillary openings of the spin block where the filaments were drawn at a rate of approximately 4000 m/min. The resulting substantially continuous filaments were deposited onto a laydown belt with vacuum suction to form a spunbond web having a basis weight of 11 g/m². The spunbond filaments had an effective diameter in the range of 15 to 17 micrometers. The use of a post-coalescence spinneret resulted in very robust spinning, i.e., there were no broken filaments or polymer drips. None of the spinning holes exhibited visible dog-legging. The filaments were well quenched and laid down to form a uniform sheet. The sheet was lightly bonded at a temperature of 105° C. and 50 pounds/linear inch nip pressure.

### EXAMPLE 2

This example illustrates preparation of a side-by-side bicomponent spunbond web from a isotactic polypropylene component and a polyethylene component having significantly different viscosities using a post-coalescence spinneret.

The spunbond web was made using an apparatus like that described above with regard to FIGS. 1 and 2. The spunbond bicomponent filaments were made from a polypropylene component available from Exxon as Exxon 1024E4 having a reported melt flow rate of 12.5 g/10 min and a linear low density polyethylene (LLDPE) component available from Dow as ASPUN 6811 A having a reported melt index of 27 g/10 minutes.

The polypropylene component was heated to 280° C. and the LLDPE component was heated to 250° C. in separate extruders. The polymers were extruded, filtered, and metered to the side-by-side post-coalescence spinneret described in Example 1, which was maintained at 295° C. The transfer lines used for transporting polymer melts to the spin-pack further heated the polypropylene component to 290° C., and the LLDPE component to 280° C. Under these temperature conditions of the spin-pack, the melt viscosity of the polypropylene component was significantly higher than the LLDPE component.

The polymer flow through each polypropylene capillary and each polyethylene capillary was adjusted to provide filaments that were 50 weight percent polypropylene and 50 weight percent LLDPE. The 1003 bicomponent filaments were cooled in a 15 inch (38.1 cm) long quenching zone with quenching air provided from two opposing quench boxes a temperature of 12° C. and velocity of 1 m/sec. The filaments passed into a pneumatic draw jet spaced 20 inches (50.8 cm) below the capillary openings of the spin block where the filaments were drawn at a rate of approximately 4000 m/min. The resulting substantially continuous filaments were deposited onto a laydown belt with vacuum suction to form a spunbond web having a basis weight of 40 g/m². The spunbond filaments had an effective diameter in the range of 17 to 19 micrometers. The use of a post-coalescence spinneret resulted in very robust spinning, i.e., there were no broken filaments or polymer drips. None of the spinning holes exhibited visible dog-legging. The filaments were well quenched and laid down to form a uniform sheet. The sheet was lightly bonded at temperature of 105° C. and 50 pounds/linear inch nip pressure.

### COMPARATIVE EXAMPLE A

This example illustrated preparation of a side-by-side bicomponent spunbond web from a polyester component and a polyethylene component having significantly different viscosities in a conventional process using a pre-coalescence spinneret in which the polymer components are joined in a layered molten mass prior to extrusion from the spinneret. The two polymers used were the same as those in Example 1.

The spin-pack used in this example was a pre-coalescence spunbonding spin-pack. The spinneret had 3360 orifices (arranged over 42 rows with a rectangular array of holes) with an orifice diameter of 0.23 mm. The two polymers were melted and extruded using the same conditions as described in Example 1. The spin-pack consisted of a set of distribution plates that combined the two polymer melt streams into a side-by-side configuration prior to the entrance of the spinneret capillaries in the distribution plates.

Attempts to spin the polymers using the described process resulted in severe dog-legging and difficulties in spinning. An attempt was made to spin at a throughput per hole of 0.5 g/min/orifice at a polymer ratio of 50:50 by weight. Severe dog-legging through virtually every polymer capillary negated any attempt to make sheet samples. The polymer melt streams exiting the capillaries bent towards the spinneret face, stuck to the spinneret face and then dripped as a molten mass. Some changes in the usual process variables in spunbond process including polymer temperatures, polymer ratios, throughput per orifice yielded no success in preventing dog-legging of polymer streams.

What is claimed is:

1. A method for forming a spunbond web, comprising the steps of:
providing a spin pack comprising a spinneret having at least one face encompassing a plurality of combined orifices, each combined orifice being formed by cooperating first and second extrusion capillaries, each extrusion capillary having an axis along a centerline, wherein within each combined orifice the first and second extrusion capillaries are oriented to converge toward each other in a downstream direction with an included angle between the centerlines of the first and second extrusion capillaries, the axes along the centerlines of the capillaries intersecting when extended beyond the spinneret face;
simultaneously extruding
(i) a first melt-processable polymer through the first plurality of capillaries to form a plurality of sub-streams comprising the first polymer and
(ii) a second melt-processable polymer through the second plurality of capillaries to form a plurality of sub-streams comprising the second polymer, the first polymer and second polymer having significantly different viscosities,
contacting each of the first and second polymer sub-streams issuing from each combined orifice after exiting the spinneret whereby the sub-streams fuse to form a plurality of multiple component filaments;
quenching the multiple component filaments;
drawing the multiple component filaments; and
collecting the drawn multiple component filaments on a collecting surface to form a multiple component spunbond web.

2. The method according to claim 1, wherein the included angle between the centerlines of the first and second extrusion capillaries is between about 10 and 145 degrees.

3. The method according to claim 1, wherein the included angle between the centerlines of the first and second extrusion capillaries is between about 30 and 90 degrees being

4. The method according to claim 1, wherein the included angle is between about 45 and 75 degrees.

5. The method according to claim 1, wherein the first and second polymer sub-streams travel a vertical distance between about 0.05 and 0.76 mm prior to contacting each other after exiting the spinneret.

6. The method according to claim 1, wherein the vertical travel distance is between about 0.08 and 0.51 mm.

7. The method according to claim 1, wherein the vertical travel distance is between about 0.10 and 0.30 mm.

8. The method according to claim 1, wherein the first and second polymers are in an arrangement selected from the group consisting of side-by-side configuration and eccentric sheath-core configuration.

9. The method according to any of claims 1-8, wherein the multiple component filaments are bicomponent filaments and the combination of the first and second polymers is selected form the group consisting of poly(ethylene terephthalate)/polyethylene, poly(ethylene terephthalate)/polypropylene, isotactic-polypropylene/polyethylene, atactic polypropylene/high density polyethylene, PETG/poly(trimethylene terephthalate), PETG/poly(butylene terephthalate) and non-extended polymer/extended polymer.

10. The method according to any of claims 1-8, wherein the first polymer is a non-extended polymer selected from the group consisting of poly(trimethylene terephthalate), poly(tetramethylene terephthalate), poly(trimethylene dinaphthalate), and poly(trimethylene bibenzoate) and the second polymer is an extended polymer selected from the group consisting of poly(ethylene terephthalate), poly (cyclohexyl 1,4-dimethylene terephthalate), copolymers thereof, and copolymers of ethylene terephthalate and the sodium salt of ethylene sulfoisophthalate.

11. The method according to claim 9, wherein the non-extended polymer/extended polymer is syndiotactic polypropylene/isotactic polypropylene.

12. A method for forming a spunbond web, comprising the steps of:
providing a spin pack comprising a spinneret having a face and a plurality of eccentric combined orifices, each combined orifice being formed by cooperating first and second extrusion capillaries, each extrusion capillary having an axis along a centerline, wherein within each combined orifice the first and second extrusion capillaries are oriented to converge toward each other in a downstream direction with an included angle between the centerlines of the first and second extrusion capillaries between about 10 and 145 degrees, the axes along the centerlines of the capillaries intersecting when extended beyond the spinneret face;
selecting a first melt-processable polymer and a second melt-processable polymers so as to form filaments capable of developing three-dimensional helical crimp;
simultaneously extruding
(i) the first melt-processable polymer through the first plurality of capillaries to form a plurality of sub-streams comprising a first polymer;
(ii) the second melt-processable polymer through the second plurality of capillaries to form a plurality of sub-streams comprising a second polymer, the first polymer and second polymer having significantly different viscosities,
contacting each of the first and second polymer sub-streams issuing from each combined orifice after exiting the spinneret whereby the sub-streams fuse to form a plurality of laterally eccentric multiple component filaments;
quenching the multiple component filaments to provide helically-crimpable multiple component filaments;
drawing the multiple component filaments to provide drawn helically-crimpable multiple component filaments;
heating the helically-crimpable multiple component filaments to form helically-crimped multiple component filaments; and
collecting the helically-crimped multiple component filaments on a collecting surface to form a multiple component spunbond web.

13. The method according to claim 12, wherein the heating step is selected from one of the group consisting of passing the filaments through a pneumatic draw jet supplied with a heated attenuating gas and heating the filaments under tension on heated rolls.

14. The method according to claim 12, wherein the first and second polymers are in an arrangement selected from one of the group consisting of side-by-side configuration and eccentric sheath-core configuration.

15. The method according to claim 12, wherein the multiple component filaments are bicomponent filaments and the combination of the first and second polymers are selected from the group consisting of poly(ethylene terephthalate)/polyethylene, poly(ethylene terephthalate)/polypropylene, isotactic-polypropylene/polyethylene, atactic polypropylene/isotactic polypropylene, atactic polypropylene/high density polyethylene, PETG/poly(trimethylene terephthalate), PETG/poly(butylene terephthalate) and non-extended polymer/extended polymer.

16. The method according to claim 12, wherein the first polymer is a non-extended polymer selected from the group consisting of poly(trimethylene terephthalate), poly(tetramethylene terephthalate), poly(trimethylene dinaphthalate), and poly(trimethylene bibenzoate) and the second polymer is an extended polymer selected from the group consisting of poly(ethylene terephthalate), poly (cyclohexyl 1,4-dimethylene terephthalate), copolymers thereof, and copolymers of ethylene terephthalate and the sodium salt of ethylene sulfoisophthalate.

17. The method according to claim 15, wherein the non-extended polymer/extended polymer is syndiotactic polypropylene/isotactic polypropylene.

18. A method for forming a spunbond web, comprising the steps of:
providing a spin pack comprising a spinneret having a face and a plurality of eccentric combined orifices, each combined orifice being formed by cooperating first and second extrusion capillaries, each extrusion capillary having an axis along a centerline, wherein within each combined orifice the first and second extrusion capillaries are oriented to converge toward each other in a downstream direction with an included angle between the centerlines of the first and second extrusion capillaries of between about 10 and 145 degrees, the axes along the centerlines of the capillaries intersecting when extended beyond the spinneret face;
simultaneously extruding
(i) a first melt-processable polymer selected so as to form filaments capable of developing three-dimensional helical crimp through the first plurality of capillaries to form a plurality of sub-streams comprising the first polymer;
(ii) a second melt-processable polymer selected so as to form filaments capable of developing three-dimensional helical crimp through the second plurality of capillaries to form a plurality of sub-streams comprising the second polymer, the first polymer and second polymer having significantly different viscosities,
contacting each of the first and second polymer sub-streams issuing from each combined orifice after exiting the spinneret whereby the sub-streams fuse to form a plurality of laterally eccentric multiple component filaments;
quenching the multiple component filaments to provide helically-crimpable multiple component filaments;
drawing the multiple component filaments to provide drawn helically-crimpable multiple component filaments;
collecting the drawn helically-crimpable multiple component filaments on a collecting surface to form a multiple component spunbond web; and
heating the multiple component spunbond web to crimp the multiple component filaments.

19. The method according to claim 18, wherein the first and second polymer sub-streams travel a vertical distance of between about 0.05 to 0.76 mm prior to contacting each other after exiting the spinneret.

20. The method according to claim 18, wherein the multiple component filaments are bicomponent filaments and the combination of the first and second polymers are selected form the group consisting of poly(ethylene terephthalate)/polyethylene, poly(ethylene terephthalate)/polypropylene, isotactic-polypropylene/polyethylene, atactic polypropylene/high density polyethylene, PETG/poly(trimethylene terephthalate), PETG/poly(butylene terephthalate) and non-extended polymer/extended polymer.

21. The method according to claim 18, wherein the first polymer is a non-extended polymer selected from the group consisting of poly(trimethylene terephthalate), poly(tetramethylene terephthalate), poly(trimethylene dinaphthalate), and poly(trimethylene bibenzoate) and the second polymer is an extended polymer selected from the group consisting of poly(ethylene terephthalate), poly (cyclohexyl 1,4-dimethylene terephthalate), copolymers thereof, and copolymers of ethylene terephthalate and the sodium salt of ethylene sulfoisophthalate.

22. The method according to claim 20, wherein the non-extended polymer/extended polymer is syndiotactic polypropylene/isotactic polypropylene.

23. The method according to any of claims 1, 12, or 18 further comprising the step of bonding the spunbond web.

24. The method according to claim 23, wherein the bonding method is selected from the group consisting of thermal point bonding, through-air bonding, mechanical needling, and hydraulic needling.

25. The method according to claim 8, wherein the multiple component filaments are bicomponent filaments in which the first and second polymers are in an eccentric sheath-core configuration.

26. The method according to claim 25, wherein the sheath extrusion capillary is a conical annular capillary having parallel inner and outer sidewalls with the central axis therebetween, the sheath extrusion capillary forming a “C”-shaped extrusion orifice on the spinneret face, and the core capillary associated with the sheath capillary in each combined orifice being concentric with the annular sheath capillary.

27. The method according to claim 26, wherein the core extrusion capillary is aligned substantially perpendicular to the spinneret face.

28. The method according to claim 26, wherein the vertical travel distance between the spinneret face and the point of intersection of the central axes is between about 0.05 and 0.76 cm.

29. The method according to claim 25, wherein the combination of the first and second polymers of the bicomponent filaments are selected form the group consisting of poly(ethylene terephthalate)/polyethylene, poly(ethylene terephthalate)/polypropylene, isotactic-polypropylene/polyethylene, atactic polypropylene/high density polyethylene, PETG/poly(trimethylene terephthalate), PETG/poly(butylene terephthalate) and non-extended polymer/extended polymer.

30. The method according to claim 29, wherein the non-extended polymer/extended polymer is syndiotactic polypropylene/isotactic polypropylene.

31. The method according to claim 25, wherein the first polymer is a non-extended polymer selected from the group consisting of poly(trimethylene terephthalate), poly(tetramethylene terephthalate), poly(trimethylene dinaphthalate), and poly(trimethylene bibenzoate) and the second polymer is an extended polymer selected from the group consisting of poly(ethylene terephthalate), poly (cyclohexyl 1,4-dimethylene terephthalate), copolymers thereof, and copolymers of ethylene terephthalate and the sodium salt of ethylene sulfoisophthalate.
